(19) United States
(12) Patent Application Publication
(10) Pub. No.: US 2011/0191513 A1
(43) Pub. Date: Aug. 4, 2011

(54) INTERRUPT CONTROL METHOD AND SYSTEM

(75) Inventors: Chang-Cheng YAP, Hsinchu (TW); Ching-Yun CHENG, Hsinchu (TW)

(73) Assignee: RDC Semiconductor Co., Ltd., Hsinchu (TW)

(21) Appl. No.: 12/900,031

(22) Filed: Oct. 7, 2010

(30) Foreign Application Priority Data
Feb. 3, 2010 (TW) 099103244

(51) Int. Cl. G06F 13/24

(52) U.S. Cl. 710/266; 710/269

(57) ABSTRACT

An interrupt control system comprises: a central processing unit (CPU); a peripheral device; an interrupt controller, and an interrupt preprocessing circuit. The peripheral device optionally issues an interrupt request, and the interrupt controller generates and outputs a first interrupt request signal in response to the interrupt request. The interrupt preprocessing circuit generates and outputs two first interrupt acknowledgement signals to the interrupt controller in response to the first interrupt request signal. An interrupt vector is generated and outputted by the interrupt controller in response to the two first interrupt acknowledgement signals, and the interrupt vector is transmitted to the CPU through the interrupt preprocessing circuit.

### FIELD OF THE INVENTION

The present invention relates to interrupt control method and system, and more particularly to interrupt control method and system utilizing an interrupt preprocessing circuit.

### BACKGROUND OF THE INVENTION

It is well known that a personal computer (PC) adopts three different types of input/output (I/O) interrupts, which are a non-maskable interrupt (NMI), a system management interrupt (SMI), and a maskable interrupt. Generally, a peripheral device uses a maskable interrupt.

As a central processing unit (CPU) is capable of processing one external interrupt each time, it is important to use an interrupt controller to manage the communication between various peripheral devices and the CPU in the PC. Since peripheral devices are imparted with different interrupt priorities, the interrupt controller has to identify the peripheral device with the highest interrupt priority once there are a plurality of peripheral devices requesting for interruption simultaneously. In other words, the interrupt controller determines which peripheral device is the current interrupt source, and informs the CPU to execute the interrupt service program corresponding to the current interrupt source by passing an interrupt vector corresponding to the current interrupt source. In PC systems, a so-called 8259A programmable interrupt controller (referred to as 8259A) is widely used for interruption control. On the other hand, in embedded systems, similar practice is commonly implemented with an interrupt control unit. Once receiving the interrupt vector from the interrupt control unit, the CPU starts to execute the interrupt service program according to the interrupt vector, wherein the start address of the interrupt service program is provided by the programmer counter.

FIGS. 1A and 1B are a block diagram and a signal waveform diagram illustrating communication means of a conventional PC. As shown in FIG. 1A, the personal computer comprises: a CPU 101, a north bridge 103, a south bridge 105, an interrupt controller 107, and a plurality of peripheral devices 109a-109n. Among them, the north bridge 103 is electrically connected to the CPU 101 and the south bridge 105; and the interrupt controller 107 is electrically connected to the south bridge 105, CPU 101, and all peripheral devices 109a-109n. In practice, the CPU 101 and the north bridge 103 can be integrated in the same chip; the interrupt controller 107 and the south bridge 105 can be integrated in another chip.

For instance, once the peripheral device 109n requests for communication with the CPU 101, the peripheral device 109n will first notify the interrupt controller 107. After the interrupt controller 107 receives and confirms which peripheral device raises the request, the interrupt controller 107 generates and transmits an interrupt request signal (INTR) to the CPU 101 immediately. According to the specification of the 8259A interrupt controller, the interrupt controller 107 will not send the interrupt vector corresponding to the peripheral device 109n to the CPU 101 until the interrupt controller 107 has received two interrupt acknowledgement signals (INTA).

Referring to FIG. 1B, at time point t0, the interrupt controller 107 generates an interrupt request signal INTR, i.e. pulled up to a high level. After receiving the interrupt request signal INTR, the CPU 101 generates and outputs first and second interrupt acknowledgement signals (INTA_cpu) at time point t1 and time point t2, respectively, to the north bridge 103. The north bridge 103 will ignore the first interrupt acknowledgement signal (INTA_cpu) but generate a single interrupt acknowledgement signal (INTA_nb) to the south bridge 105 at time point t3 in response to the second interrupt acknowledgement signal (INTA_cpu). When receiving the interrupt acknowledgement signal (INTA_nb) sent from the north bridge 103, the south bridge 105 generates two interrupt acknowledgement signals (INTA_sb) to the interrupt controller 107 at time point t4 and time point t5, respectively.

In response to the second interrupt acknowledgement signal (INTA_sb) issued by south bridge 105 at time point t5, the interrupt controller 107 generates an interrupt vector 110 at time point t6, which is sent to the south bridge 105 via a data bus (Data_sb). Afterwards, the south bridge 105 passes the interrupt vector 122 to the north bridge 103 through another data bus (Data_nb) at time point t7. At the end, the north bridge 103 transmits the interrupt vector 114 to the CPU 103 at time point t8 through a further data bus (Data_cpu). In response, the CPU 103 starts processing the interrupt service program according to the interrupt vector 114. Depending on the implementations of communications in different systems, the interrupt controller 107 may terminate the active state of the interrupt request signal INTR, i.e. pulled down to a low level, either at time point t9, or after the CPU 103 finishes the execution of the interrupt service program.

For practicing the signal transmission, the conventional interrupt controller 107 uses a pin to trigger the interrupt request signal INTR, wherein the pin is directly connected to the CPU 101, as shown in FIG. 1A. After receiving the interrupt request signal INTR, the CPU 101 is supposed to respond to the interrupt request signal INTR with two interrupt acknowledgement signals. Since the CPU 101 is not able to transmit the interrupt acknowledgement signals to the interrupt controller 107 directly, the first and second interrupt acknowledgement signals INTA_cpu as described above are sent and bypassed through the north bridge 103 and the south bridge 105 as signals INTA_nb and INTA_sb to reach the interrupt controller 107. According to the signal waveform diagram, it is found that, although the CPU sends the interrupt acknowledgement signals INTA_cpu twice, the north bridge 103 does not send an interrupt acknowledgement signal INTA_nb to the south bridge 105 until it receives the second interrupt acknowledgement signal INTA_cpu. In order to satisfy the specification of the 8259A, that is, the interrupt controller 107 has to receive the interrupt acknowledgement signals twice for reconfirmation, the south bridge 105 generates two interrupt acknowledgement signals consecutively to the interrupt controller 107 in response to the interrupt acknowledgement signal INTA_nb from the north bridge.

After receiving the second interrupt acknowledgement signal INTA_sb, the interrupt controller 107 transmits the interrupt vector to the south bridge 105 through the data bus Data_sb. After that, the interrupt vector will be propagated to the north bridge 103, and transmitted to the CPU 101 via the data bus Data_cpu. Finally, the CPU 101 starts to execute the interrupt service program corresponding to the interrupt vector.

Simply speaking, conventional CPU 101 will not start to execute the corresponding interrupt service program until the interrupt controller 107 replies with the interrupt vector. As a result, a lot of waiting time is consumed.

In others words, the interrupts requested by the peripherals cannot be responded in real time.

### SUMMARY OF THE INVENTION

Therefore, the present invention provides interrupt control method and system, which reduces waiting time of the CPU in response to the interrupt request sent by peripheral devices.

The present invention provides an interrupt control system, comprising: a central processing unit (CPU); a peripheral device optionally issuing an interrupt request; an interrupt controller in communication with the peripheral device, generating and outputting a first interrupt request signal in response to the interrupt request; and an interrupt preprocessing circuit in communication with the interrupt controller and the CPU, generating and outputting two first interrupt acknowledgement signals to the interrupt controller in response to the first interrupt request signal, an interrupt vector is generated and outputted by the interrupt controller in response to the two first interrupt acknowledgement signals, and transmitted to the CPU through the interrupt preprocessing circuit.

The present invention provides an interrupt control method for use in a system including a CPU, an interrupt controller and an interrupt preprocessing circuit in communication with the interrupt controller and the CPU, the interrupt control method being executed by the interrupt preprocessing circuit and comprising: detecting if the interrupt controller generates a first interrupt request signal; generating and outputting two first interrupt acknowledgement signals to the interrupt controller in response to the first interrupt request signal; detecting if the interrupt controller generates an interrupt vector in response to the two first interrupt acknowledgement signals; generating and outputting a second interrupt request signal to the CPU in response to the interrupt vector from the interrupt controller; detecting if the CPU generates two second interrupt acknowledgement signals in response to the second interrupt request signal; and transmitting the interrupt vector to the CPU in response to the two second interrupt acknowledgement signals.

The present invention provides another interrupt control method, for use in a system including a CPU, an interrupt controller, and an interrupt preprocessing circuit. The interrupt control method comprising: detecting if the interrupt controller generates a first interrupt request signal; generating and outputting two first interrupt acknowledgement signals to the interrupt controller in response to the first interrupt request signal; detecting if the interrupt controller generates an interrupt vector in response to the two first interrupt acknowledgement signals; and outputting a second interrupt request signal and the interrupt vector to the CPU in response to the interrupt vector from the interrupt controller.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1A and 1B are a block diagram and a signal waveform diagram illustrating the communication means of a conventional PC;

FIGS. 2A, 2B and 2C are a block diagram, a signal waveform diagram and a control flow diagram illustrating interrupt control means according to a first embodiment of the present invention; and

FIGS. 3A, 3B and 3C are a block diagram, a signal waveform diagram and a control flow diagram illustrating interrupt control means according to a second embodiment of the present invention.

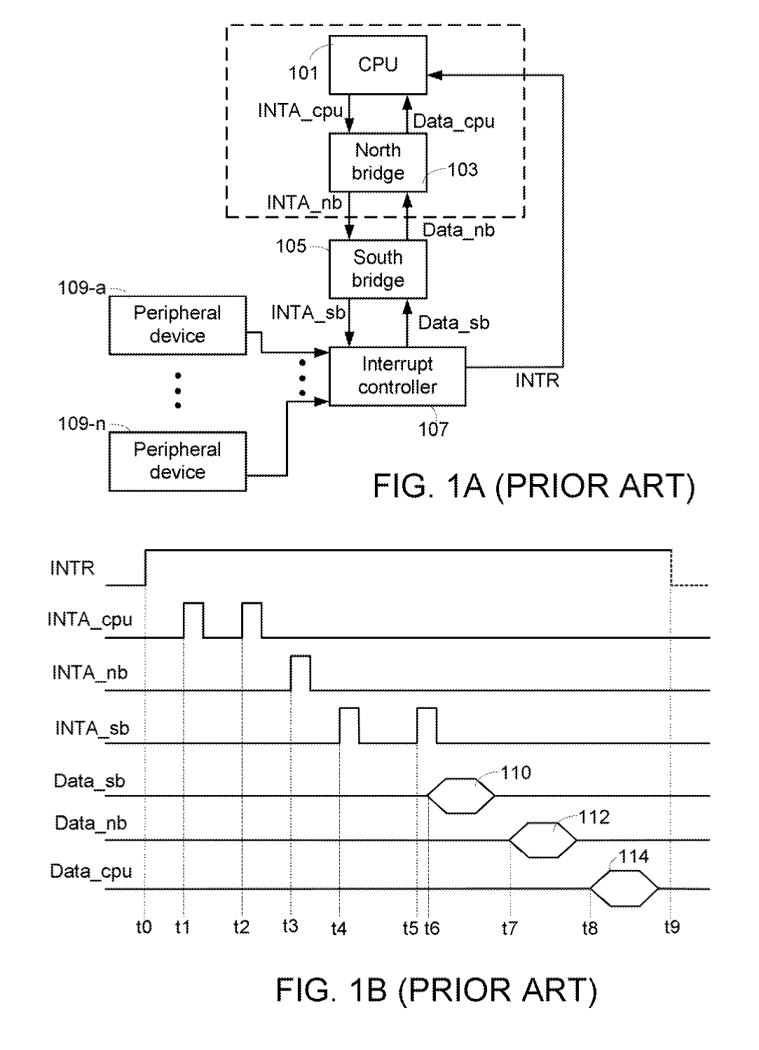

### DETAILED DESCRIPTION OF PREFERRED EMBODIMENTS

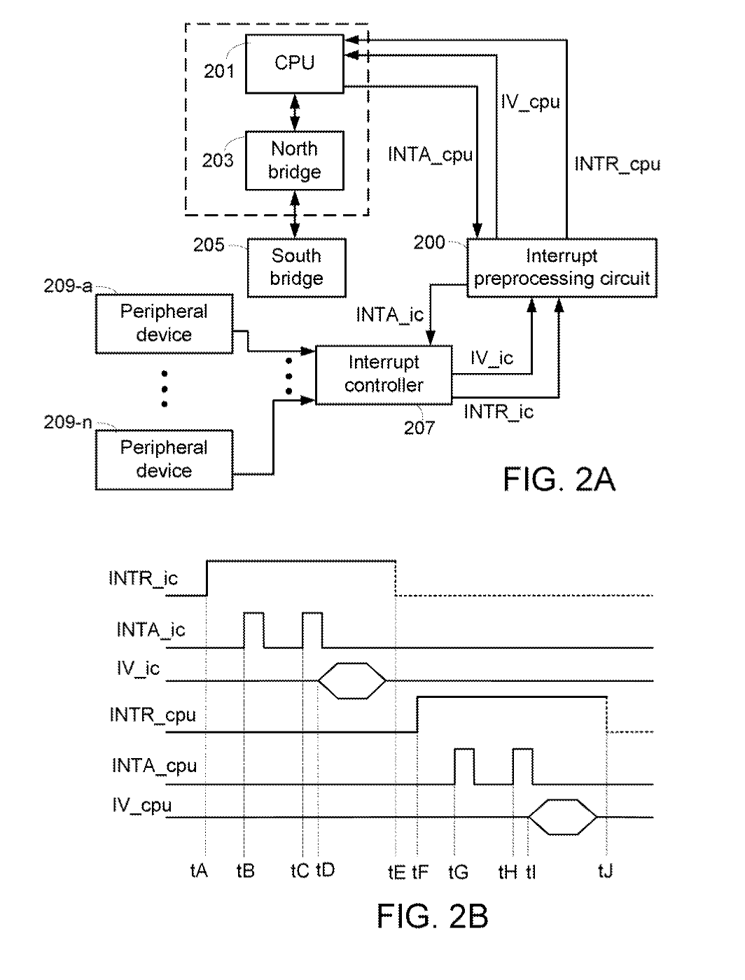

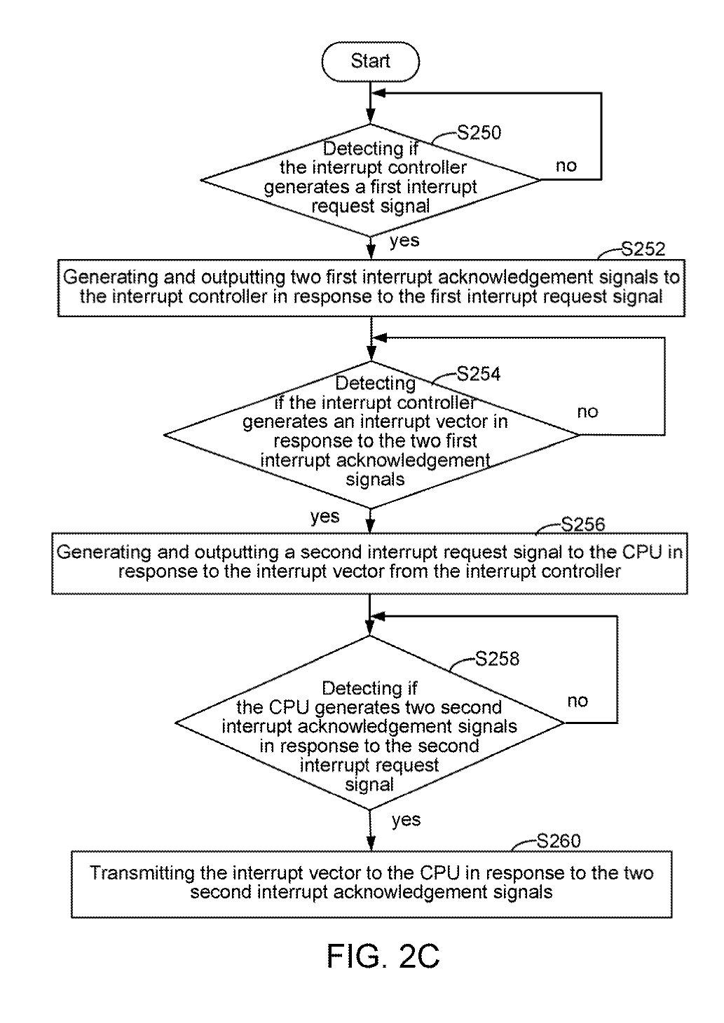

FIGS. 2A, 2B and 2C are a block diagram, a signal waveform diagram and a control flow diagram illustrating interrupt control means according to a first embodiment of the present invention. Referring to FIG. 2A, the interrupt control system includes a CPU 201, a north bridge 203, a south bridge 205, an interrupt controller 207, an interrupt preprocessing circuit 200, and a plurality of peripheral devices 209a-209n. Among them, the north bridge 203 is electrically connected to the CPU 201 and the south bridge 205, and the interrupt preprocessing circuit 200 is electrically connected to the CPU 201 and the interrupt controller 207. The interrupt controller 207 is further electrically connected to all peripheral devices 209a-209n. Moreover, it is possible that the CPU 201 and the north bridge 203 are integrated in the same chip, and/or integrate the interrupt controller 207 and the south bridge 205 in the same chip.

According to the embodiment of the present invention, when the peripheral device 209n needs to communicate with the CPU 201, the peripheral device 209n notifies the interrupt controller 207. After the interrupt controller 207 identifies the peripheral device 209n as the one sending the interrupt signal, the interrupt controller 207 generates and outputs an interrupt request signal INTR_ic to the interrupt preprocessing circuit 200.

It is to be noted that the interrupt preprocessing circuit 200 is depicted in FIG. 2A as a functional block separate from other elements for illustrating the interrupt control behavior only. As a matter of fact, the interrupt preprocessing circuit 200 may stand alone or be embedded in, for example, the north bridge 203 or the south bridge 205, depending on practical requirements.

According to FIG. 2B, the interrupt controller 207 generates an interrupt request signal INTR_ic, e.g. pulled up to a high level, at time point tA. Once the interrupt preprocessing circuit 200 receives the interrupt request signal INTR_ic, the interrupt preprocessing circuit 200 generates and outputs first and second interrupt acknowledgement signals INTA_ic to the interrupt controller 207 at time point tB and time point tC, respectively. In response, the interrupt controller 207 generates an interrupt vector IV_ic at time point tD and transmits the interrupt vector IV_ic to the interrupt preprocessing circuit 200. With different communication protocols, the time point that the interrupt controller 207 terminates the active state of the interrupt request signal INTR_ic, e.g. pulled down to a low level, may vary. For example, the interrupt request signal INTR_ic may be pulled down at time point tE, or after time point tE in a subsequent process.

Furthermore, when the interrupt preprocessing circuit 200 receives the interrupt vector IV_ic sent from the interrupt controller 207 at time point tD, the interrupt preprocessing circuit 200 generates and outputs an interrupt request signal INTR_cpu to the CPU 201 at time point tF. After receiving the interrupt request signal INTR_cpu from the interrupt preprocessing circuit 200, the CPU 201 responds to the interrupt request signal INTR_cpu with first and second interrupt acknowledgement signals INTA_cpu transmitted to the interrupt preprocessing circuit 200 at time point tG and time point tH, respectively. After receiving the interrupt acknowledgement signals INTA_cpu, the interrupt preprocessing circuit 200 transmits a corresponding interrupt vector IV_cpu to the CPU 201 at time point t1, followed by terminating the transmission of the interrupt request signal INTR_cpu at time point tJ or thereafter. Regarding the sending of the interrupt request signal INTR_cpu and interrupt vector IV_cpu from the interrupt preprocessing circuit 200 to the CPU 201, the approaches may vary with practical requirements. For example, these signals may be transmitted in parallel or in series.

According to the explanations above, the interrupt controller 207 outputs the interrupt request signal INTR_ic and the interrupt vector IV_ic to the interrupt preprocessing circuit 200. That is, the CPU 201 is not aware of the interrupt between the time point to and the time point tE. Therefore, the CPU 201 continues executing programs without delay. The CPU 201 receives INTR_cpu outputted by the interrupt preprocessing circuit 200 at time point tF.

As the CPU 201 is directly connected to the interrupt preprocessing circuit 200, and the interrupt preprocessing circuit 200 has received the interrupt vector IV_ic generated and outputted by the interrupt controller 207, the communication between the CPU 201 and peripheral devices is more efficient. As a result, after the second interrupt acknowledgement signal INTA_cpu generated at time point tH, the interrupt preprocessing circuit 200 can transmit the interrupt vector IV_cpu to the CPU 201 at time point t1, and start to execute the interrupt service program corresponding to the interrupt vector IV_cpu at time point tJ. In other words, it costs the CPU 201 only (tJ-tF) duration to receive the interrupt vector IV_cpu. After that, the CPU 201 starts to execute the interrupt service program corresponding to the interrupt vector as soon as it receives the interrupt vector.

FIG. 2C is a schematic diagram illustrating the control flow of the interrupt preprocessing circuit. First, the interrupt preprocessing circuit 200 continuously detects if the interrupt controller generates a first interrupt request signal INTR_ic (step S250). When the interrupt preprocessing circuit 200 acknowledges the interrupt controller 207 has generated the interrupt request signal INTR_ic, the interrupt preprocessing circuit 200 generates and outputs two first interrupt acknowledgement signals to the interrupt controller 207 in response to the first interrupt request signal (step S252). Afterwards, the interrupt preprocessing circuit 200 continues to detect if the interrupt controller generates an interrupt vector IV_ic in response to the two first interrupt acknowledgement signals (step S254).

Once the interrupt preprocessing circuit 200 confirms that it has received the interrupt vector IV_ic from the interrupt controller 207, the interrupt preprocessing circuit 200 generates and outputs a second interrupt request signal INTR_cpu to the CPU 201 in response to the interrupt vector from the interrupt controller (step S256). Afterwards, the interrupt preprocessing circuit 200 continues to detect if the CPU 201 generates two second interrupt acknowledgement signals INTA_ic in response to the second interrupt request signal (step S258). After the interrupt preprocessing circuit 200 acknowledges that the CPU 201 has generated two interrupt acknowledgement signals INTA_cpu, the interrupt preprocessing circuit 200 transmits the interrupt vector to the CPU 201 in response to the two second interrupt acknowledgement signals (step S260).

As conventional CPU 201 needs to send two interrupt acknowledgement signals INTA to fit the specification of the interrupt controller 207. Therefore, the interrupt preprocessing circuit 200 in the first embodiment of the present invention is able to shorten the duration between the generation of the interrupt acknowledgement signal and the receiving of the interrupt vector without modifying the design of the CPU 201 and the interrupt controller 207.

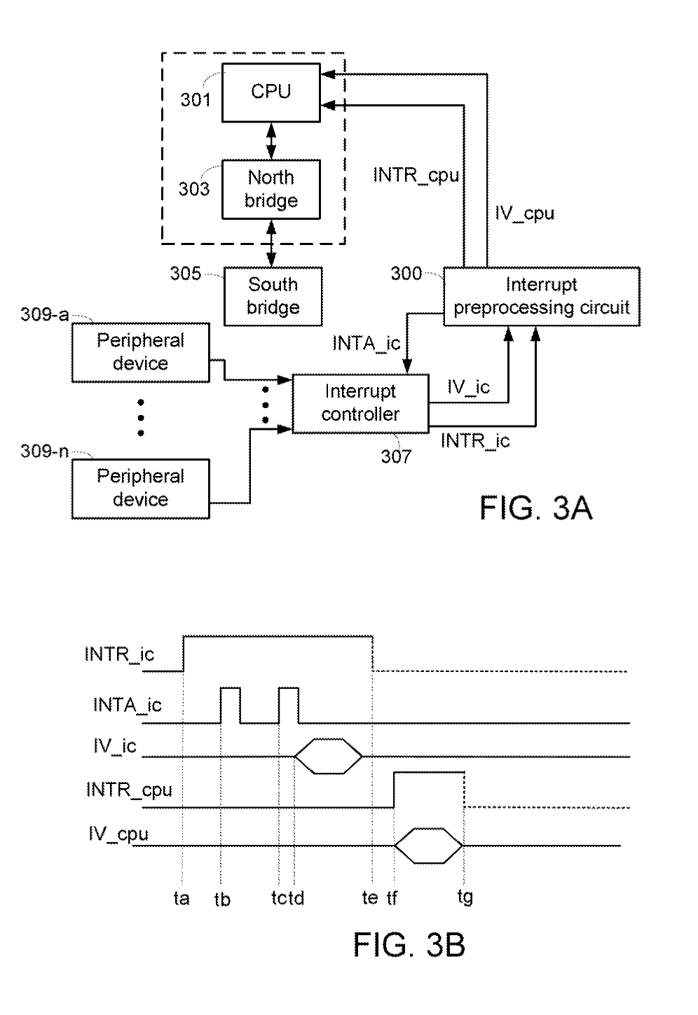

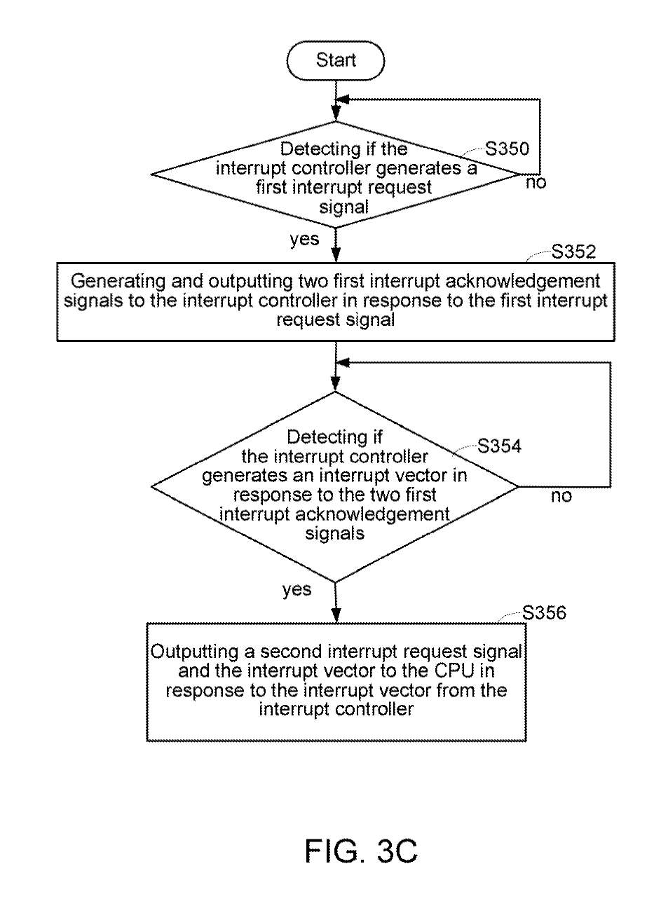

FIGS. 3A, 3B and 3C are a block diagram, a signal waveform diagram and a control flow diagram illustrating interrupt control means according to a second embodiment of the present invention. Referring to FIG. 3A, the interrupt control system includes a CPU 301, a north bridge 303, a south bridge 305, an interrupt controller 307, an interrupt preprocessing circuit 300, and a plurality of peripheral devices 309a-309n. Among them, the north bridge 303 is electrically connected to the CPU 301 and the south bridge 305, and the interrupt preprocessing circuit 300 is electrically connected to the CPU 301 and the interrupt controller 307. The interrupt controller 307 is further electrically connected to all peripheral devices 309a˜309n. Moreover, it is possible that the CPU 301 and the north bridge 303 are integrated in the same chip, and/or integrate the interrupt controller 307 and the south bridge in the same chip. The specification of the CPU 301 in this embodiment is slightly modified so that the CPU 301 is capable of receiving the interrupt vector more quickly.

According to the embodiment of the present invention, when the peripheral device 309n needs to communicate with the CPU 301, the peripheral device 309n notifies the interrupt controller 307. After the interrupt controller 307 identifies the peripheral device 309n as the one sending the corresponding signal to the interrupt controller 107, the interrupt controller 307 generates and outputs an interrupt request signal INTR_ic to the interrupt preprocessing circuit 300.

It is to be noted that the interrupt preprocessing circuit 300 is depicted in FIG. 3A as a function block separate from other elements for illustrating the interrupt control behavior only. As a matter of fact, the interrupt preprocessing circuit 300 may stand alone or be embedded in, for example, the north bridge 303 or the south bridge 305, depending on practical requirements.

According to FIG. 3B, the interrupt controller 307 generates an interrupt request signal INTR_ic, e.g. pulled up to a high level, at time point ta. Once the interrupt preprocessing circuit 300 receives the interrupt request signal INTR_ic, the interrupt preprocessing circuit 300 generates and outputs first and second interrupt acknowledgement signals INTA_ic to the interrupt controller 307 at time point tb and time point tc respectively. In response, the interrupt controller 307 generates an interrupt vector IV_ic and transmits to the interrupt preprocessing circuit 300 at time point td, and finishes transmitting the interrupt vector at time point te. With different system applications, the time point that the interrupt controller 307 terminates sending the active state of the interrupt request signal INTR_ic, e.g. pulled down to a low level, may vary. For example, the interrupt request signal INTR_ic may be pulled down at time point te, or after time point te in a subsequent process

Furthermore, the CPU 301 is slightly modified in the second embodiment. Instead of receiving the interrupt acknowledgement signal from the CPU 301, the interrupt preprocessing circuit 300 generates and outputs an interrupt request signal INTR_cpu and an interrupt vector IV_cpu to the CPU 301. Regarding the sending of the interrupt request signal INTR_cpu and interrupt vector IV_cpu from the interrupt preprocessing circuit 300 to the CPU 301, the approaches may vary with practical requirements. For example, these signals may be transmitted through different signal lines or use the same signal line to transmit in series.

According to FIG. 3B, the interrupt preprocessing circuit 300 receives the interrupt vector IV_ic at time point td, and generates and outputs an interrupt request signal INTR_cpu and the interrupt vector IV_cpu to the CPU 301 at time point tf. Therefore, the CPU 301 receives interrupt vector IV_cpu and starts to execute the corresponding interrupt processing program at time point tg or after.

Instead of generating and outputting the interrupt request signal INTR_ic and the interrupt vector IV_ic to the CPU 301 directly, the interrupt controller 307 passes the interrupt request signal INTR_ic and the interrupt vector IV_ic to the interrupt preprocessing circuit 300 first. In other words, the CPU 301 continues executing routine programs between the time point to and the time point te. After receiving the interrupt request signal INTR_cpu and the interrupt vector IV_cpu at time point tf, the CPU 301 starts to proceed the interrupt program according to the interrupt vector IV_cpu at time tg. That is, it takes the CPU 301 (tg-tf) to receive the interrupt vector IV_cpu.

FIG. 3C is a schematic diagram illustrating the control flow of the interrupt preprocessing circuit. First, the interrupt preprocessing circuit 300 keeps detecting if the interrupt controller generates a first interrupt request signal INTR_ic (step S350). The interrupt preprocessing circuit 300 generates and outputs two first interrupt acknowledgement signals to the interrupt controller in response to the first interrupt request signal (step S352). Furthermore, the interrupt preprocessing circuit 300 continues to detect if the interrupt controller 307 generates an interrupt vector IV_ic in response to the two first interrupt acknowledgement signals (step S354).

Once the interrupt preprocessing circuit 300 confirms that it has received the interrupt vector IV_ic from the interrupt controller 307, the interrupt preprocessing circuit 300 outputs a second interrupt request signal INTR_cpu and the interrupt vector IV_cpu to the CPU in response to the interrupt vector from the interrupt controller (step S356).

It is noted that, according to the second embodiment, the design of the CPU 301 is properly modified that the interrupt vector is received more quickly.

This invention proposes an interrupt control method and an interrupt control system. By providing an interrupt preprocessing circuit between the interrupt controller and the CPU, the CPU receives the interrupt vector more efficiently. In practice, the interrupt preprocessing circuit may stand alone or be embedded in, for example, the north bridge or the south bridge, depending on practical requirements. Instead of propagating interrupt acknowledgement signals and the interrupt vector gradually as the conventional approach, the present invention solves the problem that the CPU wastes too much time in waiting for the interrupt vector.

Although the above embodiments use computer systems for illustration, but similar approaches can also be applied to other micro controller systems with interrupt control function, whether the micro controller is a general processor or a DSP. By bridging the interrupt controller and the CPU with the interrupt preprocessing circuit, the present invention speeds up the reaction of the CPU for interrupts issued by peripheral devices.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interrupt control system, comprising:
a central processing unit (CPU);
a peripheral device optionally issuing an interrupt request;
an interrupt controller in communication with the peripheral device, generating and outputting a first interrupt request signal in response to the interrupt request; and
an interrupt preprocessing circuit in communication with the interrupt controller and the CPU, generating and outputting two first interrupt acknowledgement signals to the interrupt controller in response to the first interrupt request signal, an interrupt vector is generated and outputted by the interrupt controller in response to the two first interrupt acknowledgement signals, and transmitted to the CPU through the interrupt preprocessing circuit.

2. The interrupt control system according to claim 1, wherein the interrupt preprocessing circuit outputs a second interrupt request signal to the CPU after receiving the interrupt vector, and transmits the interrupt vector to the CPU in response to two second interrupt acknowledgement signals issued by the CPU to the interrupt preprocessing circuit.

3. The interrupt control system according to claim 1, wherein the interrupt preprocessing circuit outputs a second interrupt request signal and transmits the interrupt vector to the CPU after the interrupt preprocessing circuit receives the interrupt vector from the interrupt controller.

4. The interrupt control system according to claim 1, wherein the CPU executes an interrupt service program according to the interrupt vector.

5. The interrupt control system according to claim 1, wherein the interrupt controller is an 8259A programmable interrupt controller.

6. An interrupt control method for use in a system including a CPU, an interrupt controller and an interrupt preprocessing circuit in communication with the interrupt controller and the CPU, the interrupt control method being executed by the interrupt preprocessing circuit and comprising:
detecting if the interrupt controller generates a first interrupt request signal;
generating and outputting two first interrupt acknowledgement signals to the interrupt controller in response to the first interrupt request signal;
detecting if the interrupt controller generates an interrupt vector in response to the two first interrupt acknowledgement signals;
generating and outputting a second interrupt request signal to the CPU in response to the interrupt vector from the interrupt controller;
detecting if the CPU generates two second interrupt acknowledgement signals in response to the second interrupt request signal; and
transmitting the interrupt vector to the CPU in response to the two second interrupt acknowledgement signals.

7. The interrupt control method according to claim 6, wherein the CPU executes an interrupt service program according to the interrupt vector.

8. An interrupt control method for use in a system including a CPU, an interrupt controller, and an interrupt preprocessing circuit, the interrupt control method comprising:
detecting if the interrupt controller generates a first interrupt request signal;
generating and outputting two first interrupt acknowledgement signals to the interrupt controller in response to the first interrupt request signal;
detecting if the interrupt controller generates an interrupt vector in response to the two first interrupt acknowledgement signals; and
outputting a second interrupt request signal and the interrupt vector to the CPU in response to the interrupt vector from the interrupt controller.

9. The interrupt control method according to claim 8, wherein the CPU executes an interrupt service program according to the interrupt vector.
